(19) United States
(12) Patent Application Publication
(10) Pub. No.: US 2026/0028871 A1
(43) Pub. Date: Jan. 29, 2026

(54) Door Threshold

(71) Applicant: Clayton Supply, Inc., Maryville, TN (US)

(72) Inventors: Erik Garry Batson, College Grove, TN (US); Aaron Rummel, Knoxville, TN (US)

(73) Assignee: Clayton Supply, Inc., Maryville, TN (US)

(21) Appl. No.: 18/782,773

(22) Filed: Jul. 24, 2024

(51) Int. Cl. E06B 1/70; E06B 1/12

(52) U.S. Cl. CPC E06B 1/70; E06B 1/12

(57) ABSTRACT

A door sill apparatus for a manufactured home comprising a substrate having an inner edge and an outer edge and a threshold member configured to be removably secured to the substrate, the threshold member having a deck at least partially covering the substrate, an upper surface, an opposing lower surface, and a deck support having a base leg, a drip leg, and a cross support connecting the base leg to the drip leg. The base leg and drip leg extend downward from the deck such that the base leg contacts the subfloor of the manufactured home, reinforcing the threshold member. The drip leg extends below the plane in which the subfloor and substrate, preventing water intrusion. The cross member connects the base leg and the drip leg and stiffens and reinforces the portion of the deck extending past where the base leg extends downward.

### FIELD

This disclosure generally relates to the field of exterior door sill constructions. More particularly, this disclosure is directed to an improved door threshold with additional supports.

### BACKGROUND

Door sills are crucial components of exterior door frames, essential for creating a proper seal between the interior of a building and the elements. Properly functioning sills prevent water and air from entering buildings, but left unprotected, are prone to damage and degradation due to falling objects, regular foot traffic, and the accumulation of moisture around the sill, among numerous other causes. Because door sill replacement can be complicated and expensive, door sills commonly employ protective apparatuses like door thresholds to maintain the integrity of the sills. Typically, thresholds share a common construction, being sloped toward the outside to prevent the accumulation of moisture around the sill and made from durable materials to withstand foot traffic.

Prior threshold designs fail to provide similar, adequate benefits for manufactured homes and other buildings, however, which are assembled partially or entirely at an off-site manufacturing facility and then relocated to a piece of property where they may be installed either permanently or temporarily. Off-site construction techniques and assembly significantly speed the building process but, in some instances, can introduce issues not encountered in traditional construction techniques involving slab foundations. In this regard, prior threshold designs that may be designed to properly bear the full weight of an object or individual passing across the sill of a slab-constructed home or other building, when used in manufactured homes, may provide unsatisfactory results in various respects. In particular, prior threshold designs can deflect a significant amount causing the threshold itself to bend and degrade, in turn causing caulking or other sealants applied adjacent to the threshold to crack and degrade, may allow water running down the slope of the top of the threshold to migrate to the underside of the threshold, and are dimensioned such that they can create unwanted voids underneath the threshold and next to the sill substrate where water and moisture may accumulate and degrade the substrate, subfloor, joists, and other supporting structures.

Accordingly, what is desired is a resilient, easy-to-use, and low-cost apparatus for protecting a door sill.

### SUMMARY

The above and other needs are met by a door sill apparatus having additional supports.

In one embodiment, the door threshold member is configured to be removably secured to a substrate attached to a subfloor. The door threshold member includes a deck configured to at least partially cover the substrate. A deck support may include a lower securing leg adjacent the outer substrate edge, a base leg extending down from the bottom of the deck to an upper subfloor surface between the lower securing leg and an outer edge of the subfloor, and a drip leg adjacent an outer edge of the deck extending down a length that is longer than the base leg.

The base leg may include a foot portion extending perpendicularly inward toward the substrate. In certain embodiments, the foot portion extends to and is connected to the lower securing leg. In some instances, the base leg and/or the drip leg is parallel to the outer edge of the substrate.

A cross support may also be connected to the base leg and the drip leg. In some embodiments, the cross support has a slope from the base leg to the drip leg with an angle that ranges from about 0 degrees to about 45 degrees from horizontal.

An upper securing leg may also extend downward from the lower surface of the deck and have a foot portion extending from its end. The foot portion is therefrom dimensioned and configured to be at least partially disposed within an upper groove in the substrate. In some cases, the foot portion extends perpendicularly toward the outer edge of the substrate.

In some embodiment, the lower securing leg includes a foot portion extending into a lower groove in the substrate adjacent the subfloor.

The door sill apparatus may also include a sill cap configured to be removably secured to the substrate.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a cross-sectional side view of a door sill apparatus in accordance with an embodiment of the present disclosure having a base leg with a foot portion;

FIG. 2 is a cross-sectional side view of a door sill apparatus in accordance with an alternative embodiment of the present disclosure having a base leg with a foot portion connected to a securing leg;

FIG. 3 is a top plan view of a door sill apparatus in accordance with an embodiment of the present disclosure having a base leg with a foot portion; and

FIG. 4 is a top plan view of a door sill apparatus in accordance with an alternative embodiment of the present disclosure having a base leg with a foot portion connected to a securing leg.

### DETAILED DESCRIPTION

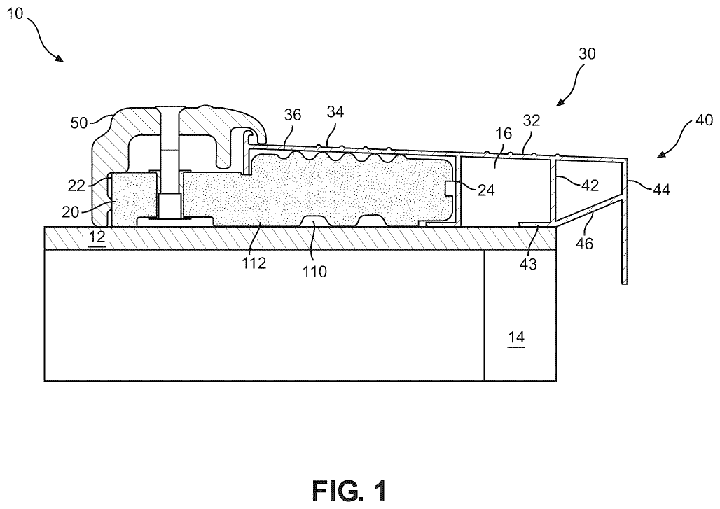

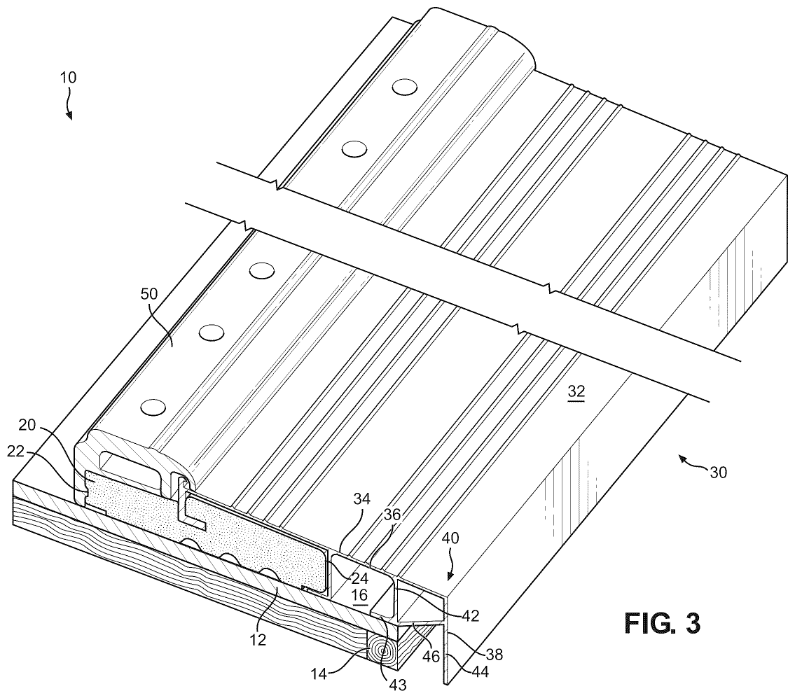

Depicted in FIGS. 1-4 are door sill apparatuses 10 and 60 for manufactured homes. Shown in FIGS. 1 and 3, the door sill apparatus 10 preferably includes at least a substrate 20 having an inner edge 22 and an opposing outer edge 24 and a threshold member 30 configured to be attached to the substrate 20. In various embodiments, the threshold member 30 may be configured to be removably secured to the substrate 20, such as by slotting the threshold member 30 into the substrate 20, shown in FIGS. 1-4, by fastening a sill cap 50 over a portion of the threshold member 30 and into the substrate 20, shown in FIG. 1, or a combination of both. The threshold member 30 has a deck 32 having an upper surface 34 and an opposing lower surface 36 that at least partially extends over the substrate 20.

Detailed in FIGS. 1 and 3, preferably, the substrate 20 is attached to the subfloor 12 through the use of adhesive, fasteners, or other similar suitable methods of attachment, and the outer edge 38 of the deck 32 extends further beyond the outer edge 24 of the substrate 20 over the subfloor 12 and past the edge of the rim joist 14, which defines the outer edge of the bottom of the door frame of the manufactured home. In instances in which it is preferable to use adhesive, the substrate 20 may further include a plurality of channels 110 disposed on a bottom edge 112 of the substrate 20, in order to create a more effective seal between the subfloor 12 and the substrate 20. The channels 110 may take any number of shapes or cross sections, including circular, triangular, or rectangular. The deck 32 further includes a deck support 40 configured to support the portion of the deck 32 extending beyond the outer edge 24 of the substrate 20. The deck support 40 enables the threshold member 30 to resist excessive and damaging deflection when a load is applied to the threshold member 30 by efficiently distributing the load placed on the deck 32 via, for example, a person stepping directly onto the upper surface 34 of the portion of the deck 32 extending past the outer edge 24 of the substrate 20.

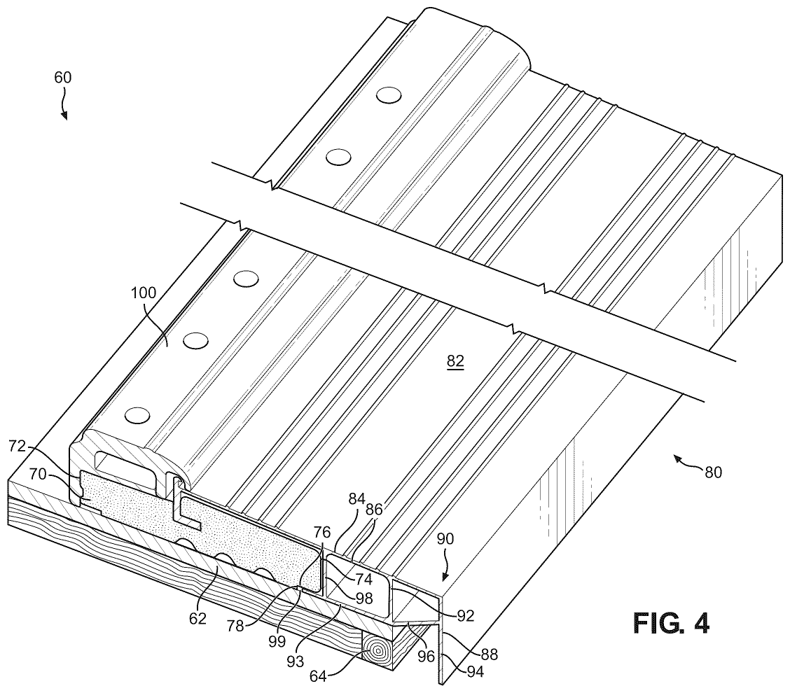

The deck support 40 distributes the load by virtue of several structures extending down from the lower surface 36 of the deck 32, including a base leg 42, a drip leg 44, and a cross support 46. When the threshold member 30 is attached to substrate 20, the base leg 42 is configured to contact the subfloor 12 at a point between the outer edge of the 24 of the substrate and the edge of the rim joist 14. Thus, a load applied to the deck 32 is distributed to the subfloor 12 and joists of the manufactured home. In some embodiments, the base leg 42 extends down from the lower surface 36 of the deck 32 parallel to the outer edge 24 of the substrate 20 and further includes a foot portion 43 extending perpendicularly from the base leg 42. Shown in FIGS. 1 and 4, the foot portion 43 extends perpendicularly inward in the direction of the substrate 20 and contacts the subfloor 12. The foot portion 43 expands the surface area over which a load applied to the threshold 30 is directed into the subfloor 12 and joists of the manufactured home, reducing the amount of pressure, and thus deflection, applied at the point of contact between the threshold 30 and the subfloor 12 thereby lessening fatigue and degradation in the threshold 30 and the subfloor 12 at the point of contact and preventing the base leg 42 from slipping past the outer edge of the rim joist 14. Installed, the base leg 42 also operates to close off a void 16 between the subfloor 12 and the threshold member 30 that would otherwise be open and allow the accumulation of water and moisture.

Shown in FIG. 1, when the threshold member 30 is attached to the substrate 20, the drip leg 44 is configured to extend down from the lower surface 36 of the deck 32 parallel to the outer edge 24 of the substrate 20, past the plane at which the substrate 20 contacts the subfloor 12. Thus, the drip leg 44 defines the outer edge 38 of the deck 32 such that any water running down the upper surface 34 of the deck 32 is directed down the drip leg 44 and off of the threshold member 30 at a point that limits migration of water or other moisture into any void 16 between the subfloor and the threshold member 30. Additionally, the drip leg 44 provides the threshold member 30 with additional resistance to bending, similar in effect to an “I-beam.” The drip leg 44 also serves to hide seams between the subfloor 12, rim joist 14, and any siding that may be applied to the manufactured home, preventing water or moisture from accumulating at those points and improving the overall aesthetic of the entryway.

Shown in FIG. 1, the deck support 40 further includes a cross support 46 connecting the base leg 42 to the drip leg 44. The cross support 46 reinforces the deck support 40 by allowing for the more efficient distribution of a load applied to the threshold 30 past the point at which the base leg 42 extends downward from the lower surface 36 of the deck 32 via a cantilever effect. The deck 32 would be otherwise unsupported past this point, and thus the cross support 46 distributes loads past this point to the base leg 42 and into the subfloor 12 and joists of the manufactured home. Shown in FIG. 1, the cross support 46 may be formed from a straight piece of material that may extend either perpendicularly between the base leg 42 and the drip leg 44 or at an angle from horizontal ranging from about 0 degrees to about 45 degrees.

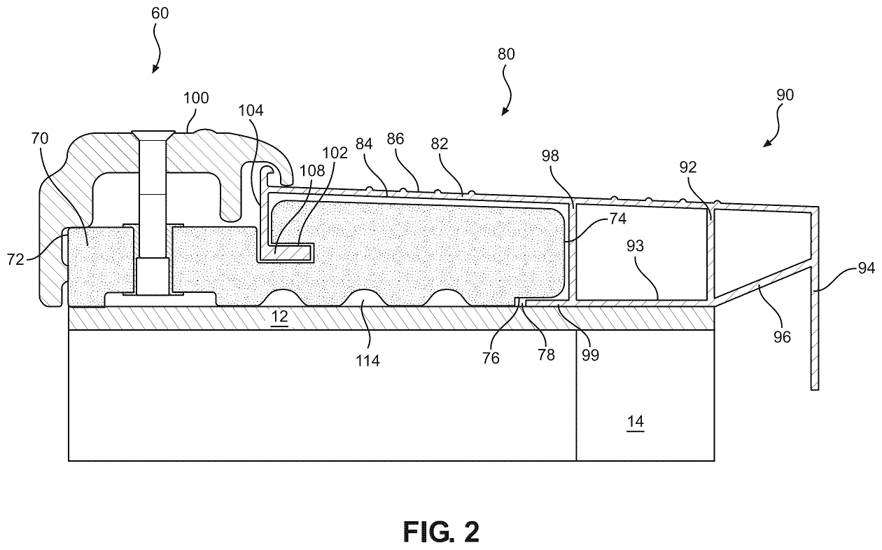

The deck support may take various other embodiments while still employing the same or similar load distribution capabilities. For example, detailed in FIGS. 2 and 4, in some embodiments, the deck support 90 may include a securing leg 98 in addition to a base leg 92, a drip leg 94, and cross support 96. In the embodiment detailed in FIGS. 2 and 4, the door sill apparatus 60—like door sill apparatus 10—includes a substrate 70 having an inner edge 72, an outer edge 74, an upper groove 102, and a lower groove 78 and a threshold member 80 configured to be attached to the substrate 70. The threshold member 80 has a deck 82 having an upper surface 86 and an opposing lower surface 84 that at least partially extends over the substrate 70, the upper surface 86 thereby protecting the substrate 80 from foot traffic overtop of the door sill apparatus 60.

Shown in FIGS. 2 and 4, preferably the substrate 70 is attached to the subfloor 62 through the use of adhesive, fasteners, or other similar suitable methods of attachment, and the outer edge 88 of the deck 82 extends further beyond the outer edge 74 of the substrate 70 over the subfloor 62 and past the edge of the rim joist 64, which defines the outer edge of the bottom of the door frame of the manufactured home. In instances in which it is preferable to use adhesive, the substrate 70 may further include a plurality of channels 114 disposed on a bottom edge of the substrate 70, in order to create a more effective seal between the subfloor 62 and the substrate 70. The channels 114 may take any number of shapes or cross sections, including circular, triangular, or rectangular. Shown in FIGS. 2 and 4, the deck support 90 of the deck 82 is configured to both removably secure the threshold 80 of the sill apparatus 60 to the substrate 70 as well as support the portion of the deck 82 extending beyond the outer edge 74 of the substrate 70, in part leveraging the way in which the threshold 80 is secured to the substrate 70.

In various embodiments, the threshold member 80 may be further removably secured to the substrate 70 by virtue of one or both of the upper securing leg 104 and lower securing leg 98. Shown in FIG. 2, the upper securing leg 104 extends downward from the lower surface 86 of the deck 82, in some embodiments defining the a second outer edge 106 of the deck 82 distal from the first outer edge 88 of the deck 82. The upper securing leg 104 further includes a foot portion 108 extending from the upper securing leg 104, dimensioned and configured to be at least partially disposed within the upper groove 102 of the substrate 70, effectively removably securing the threshold 80 to the substrate 70. The shape of the upper groove 102 and corresponding foot portion 108 may take several forms. Shown in FIGS. 2-4, for example, due to the shape of the upper groove 102, the foot portion 108 may be configured to extend perpendicularly toward the outer edge 74 of the substrate 70.

Also shown in FIG. 2, the lower securing leg 98 extends downward from the lower surface 86 of the deck 82, configured to contact the subfloor 62 at a point between the outer edge 74 of the substrate and the edge of the rim joist 64. The securing leg 98 extends down from the lower surface 86 of the deck 82 parallel to the outer edge 74 of the substrate 70 and further includes a foot portion 99 extending perpendicularly from the securing leg 98. Shown in FIGS. 2 and 4, the foot portion 99 extends perpendicularly inward in the direction of the substrate 70 such that the foot portion 99 is dimensioned and configured to be at least partially disposed within the lower groove 78 of the substrate 70, effectively removably securing the threshold 80 to the substrate 70. In some embodiments, it may be preferable to use both the upper securing leg 104 and lower securing leg 98 to secure the threshold 80 to the substrate 70 to provide even greater reinforcement between the threshold 80 and substrate 70 and thus protection of the substrate 70, as well as reinforced load distribution capabilities of the deck 82. In some embodiments, the threshold 80 may be slidably installed and/or removed from the substrate 70.

Shown in FIGS. 2 and 4, when the threshold member 80 is attached to the substrate 70, the base leg 92 is configured to contact the subfloor 62 at a point between the outer edge 74 of the substrate 70 and the edge of the rim joist 64. In some embodiments, the base leg 92 extends down from the lower surface 84 of the deck 82 parallel to the outer edge 74 of the substrate 70 and further includes a foot portion 93 extending perpendicularly from the base leg 92. Shown in FIGS. 2 and 4, the foot portion 93 contacts the subfloor 62 and extends perpendicularly inward in the direction of the substrate 70 and is connected to the securing leg 98. Combined with the foot portion 99 of the securing leg 98, the foot portion 93 of the base leg 92 maximizes the surface area over which a load applied to the threshold 80 is directed into the subfloor 62 and joists of the manufactured home, minimizing the amount of pressure, and thus deflection, applied at the point of contact between the threshold 80 and the subfloor 62 thereby lessening fatigue and degradation at the point of contact and preventing the base leg 92 from slipping past the outer edge of the rim joist 64. Further, the deck support 90 leverages the fit between the groove 78 and the foot portion 99 to further reinforce the threshold 80 as a load is applied. Installed, the base leg 92, securing leg 98, and foot portion 93 operate to effectively eliminate any void between the subfloor 62 and threshold member 80 that would otherwise be present and open, resulting in the accumulation of water and moisture.

Shown in FIG. 2, when the threshold member 80 is attached to the substrate 70, the drip leg 94 is configured to extend down from the lower surface 86 of the deck 82 parallel to the outer edge 74 of the substrate 70, past the plane at which the substrate 70 contacts the subfloor 62. Thus, the drip leg 94 defines the outer edge 88 of the deck 82 such that any water running down the upper surface 84 of the deck 82 is directed down the drip leg 94 and off of the threshold member 80 at a point that limits migration of water or other moisture into any space between the subfloor 62 and the threshold member 80. Additionally, the drip leg 94 provides the threshold member 80 with additional resistance to bending, similar in effect to an “I-beam.” The drip leg 94 also serves to hide seams between the subfloor 62, rim joist 94, and any siding that may be applied to the manufactured home, preventing water or moisture from accumulating at those points and improving the overall aesthetic of the entryway.

Shown in FIG. 2, the deck support 90 further includes a cross support 96 connecting the base leg 92 to the drip leg 94. The cross support 96 reinforces the deck support 90 by allowing for the more efficient distribution of a load applied to the threshold 80 past the point at which the base leg 92 extends downward from the lower surface 84 of the deck 82 via a cantilever effect. The deck 82 would be otherwise unsupported past this point, and thus the cross support 96 distributes loads past this point to the base leg 42 and into the subfloor 12 and joists of the manufactured home. Shown in FIG. 1, the cross support 96 may be formed from a straight piece of material that may extend either perpendicularly between the base leg 92 and the drip leg 94 or at an angle from horizontal ranging from about 0 degrees to about 45 degrees.

In preferred embodiments of the invention, all of the components of the thresholds 30, 80 of the door sill apparatuses 10, 60 are a unitary structural element formed from one piece of continuous material. In some embodiments, the thresholds 30, 80 are formed of a thermoplastic material, such as all of the components of the threshold 80 are formed from one continuous piece of material. In some embodiments, the thresholds 30, 80 are formed of polyvinyl chloride, polyethylene, polypropylene, or other thermoplastic materials with similar suitable characteristics. In preferred embodiments, the thresholds 30, 80 are formed of durable metallic materials such a aluminum, bronze, steel, iron, nickel, or other like materials with similar suitable characteristics. In preferred embodiments, the substrates 20, 70 are formed from durable natural or synthetic materials such as wood, plastic, or metal.

The nature of the method by which the door sill apparatuses 10, 60 seal the interior of a manufactured home from the elements may vary in different embodiments of the present disclosure. In some instances, the sill apparatuses 10, 60 may utilize a fixed sill cap. In other instances, shown in FIGS. 1 and 2, the sill apparatuses 10, 60 may utilize adjustable sill caps 50, 100. The sill caps 50, 100 may include various other components such as screws, channels, pads, plugs, and the like as necessary for creating, adjusting, and/or securing the seal.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A door threshold member configured to be removably secured to a substrate attached to a subfloor, the substrate having an inner substrate edge and an outer substrate edge, the door threshold member comprising a deck configured to at least partially cover the substrate, the deck having an upper deck surface and an opposing lower deck surface and further comprising a deck support having an lower securing leg configured to be adjacent the outer substrate edge, a base leg extending down from the lower deck surface a length to be adjacent an upper subfloor surface between the lower securing leg and an outer edge of the subfloor, and a drip leg adjacent an outer edge of the deck extending down a length that is longer than the base leg.

2. The door threshold member of claim 1 wherein the base leg includes a foot portion extending perpendicularly inward toward the substrate.

3. The door threshold member of claim 2 wherein the base leg extends downward from the lower surface of the deck parallel to the outer edge of the substrate.

4. The door threshold member of claim 2 wherein the foot portion extends inwardly to and is connected the lower securing leg.

5. The door threshold member of claim 1 wherein the drip leg extends downward from the lower surface of the deck parallel to the outer edge of the substrate.

6. The door threshold member of claim 1 wherein a cross support is connected to the base leg and the drip leg.

7. The apparatus of claim 6 wherein cross support has a slope from the base leg to the drip leg with an angle that ranges from about 0 degrees to about 45 degrees from horizontal.

8. The door threshold member of claim 1 wherein the deck and deck support comprise a unitary structural element.

9. The door threshold member of claim 1 wherein the deck and deck support are formed from a continuous piece of metallic material.

10. The door threshold member of claim 1 wherein an upper securing leg extends downward from the lower surface of the deck adjacent a second outer edge of the deck distal to the first outer edge of the deck, the upper securing leg having a first end connected to the deck and the second end having a foot portion extending therefrom dimensioned and configured to be at least partially disposed within an upper groove in the substrate.

11. The door threshold member of claim 10, further wherein the foot portion extends perpendicularly toward the outer edge of the substrate.

12. The door threshold member of claim 1, wherein the lower securing leg includes a foot portion extending into a lower groove in the substrate adjacent the subfloor.

13. A door threshold member configured to be removably secured to a substrate attached to a subfloor upper surface, the door threshold comprising a deck configured to at least partially cover the substrate, the deck having a drip leg extending down adjacent an outer deck edge a length sufficient to be lower than the subfloor upper surface.

14. The door threshold member of claim 13, further comprising a lower securing leg extending downward from the lower surface of the deck, with a first end connected to the deck and the second end having a foot portion extending perpendicularly inward toward the substrate dimensioned and configured to be at least partially disposed within a lower groove of the substrate.

15. The door threshold member of claim 14 wherein a base leg extends downward from the lower surface of the deck between the lower securing leg and the drip leg.

16. The door threshold member of claim 15 wherein the base leg includes a first end connected to the deck and a second end having a foot portion extending perpendicularly inward toward the substrate.

17. The door threshold member of claim 16 wherein the foot portion extends to and is connected to the lower securing leg.

18. The door threshold member of claim 15 wherein the drip leg extends downward from the lower surface of the deck parallel to the outer edge of the substrate, and further wherein the drip leg is longer than the base leg.

19. The door threshold member of claim 15 wherein a cross support is connected to the base leg and the drip leg.

20. A door sill assembly for a manufactured home, the apparatus comprising:
a substrate having an inner edge and an outer edge;
a threshold member configured to be removably secured to the substrate, the threshold member having a deck at least partially covering the substrate, the deck having an upper surface and an opposing lower surface and further comprising a deck support having a lower securing leg, a drip leg, a base leg between the lower securing leg and the drip leg, and a cross support connecting the base leg to the drip leg; and
a sill cap configured to be removably secured to the substrate.
